(19) United States
(12) Patent Application Publication
(10) Pub. No.: US 2023/0289703 A1
(43) Pub. Date: Sep. 14, 2023

(54) SYSTEM AND METHOD FOR OPERATING AN EFFECTIVE GAMIFICATION APPLICATION PURSUIT

(71) Applicant: NICE LTD., Ra'anana (IL)

(72) Inventors: Aniket PAL, Pune (IN); Sourav RATH, Pune (IN)

(21) Appl. No.: 17/693,362

(22) Filed: Mar. 13, 2022

(51) Int. Cl. G06Q 10/06

(52) U.S. Cl. CPC G06Q 10/06398; G06Q 10/06393

(57) ABSTRACT

A computerized-method for operating an effective cloud-based gamification application pursuit is provided herein. In a cloud-computing environment comprising a plurality of tenants, a cloud-based gamification application, a data store of pursuit-data, and a database of pursuit-templates, the cloud-based gamification application is associated with each on-premise Performance Management (PM) application of each tenant and operating a pursuit-module. The pursuit-module includes: (a) receiving pursuit-data, (b) operating a pursuit-microservice to retrieve data from a data-store associated to the on-premise PM application of the tenant; and (c) operating a recommendation engine to: (i) operate machine learning models to predict a difficulty-level and a pursuit-type based on the received pursuit-data and the retrieved data; (ii) retrieve pursuit-templates and a related score of each pursuit-template, based on the predicted difficulty level and pursuit type; and (iii) select from the retrieved pursuit-templates a pursuit-template and schedule the selected pursuit-template, based on the related score.

### TECHNICAL FIELD

The present disclosure relates to the field of data analysis and more specifically for operating an effective cloud-based gamification application pursuit.

### BACKGROUND

Contact centers constantly strive to motivate agents and to increase their performance. Gamification solutions are commonly used for the purpose of motivating the agents and improving their performance and rank by providing challenges, activities, quests, campaigns and tasks. Managers or supervisors in contact centers use gamification techniques to motivate, engage and improve the performance of agents. The implementation of the gamification techniques is a definition or configuration of gamification challenges for the agents having a difficulty-level and pursuit-type.

However, scheduling the right configuration of gamification application challenges e.g., difficulty-level and pursuit-type, may be crucial to sustain engagement and motivation levels of the agents. For example, an extremely difficult gamification challenge which may be given to the agents, can get the agents demotivated and disengaged. On the other hand, when some overly simplistic challenge may be given to the agents, they would end up earning reward points without much increase in their performance.

Therefore, managers or supervisors spend time and effort in configuring gamification application challenges for their agents. In current technical solutions, there is no guidance or measure as to whether a configured challenge is going to be achievable, effective and serving the purpose. As a result, managers or supervisors have to rely on their experience in order to define such challenges. Yet, this could sometimes result in the purpose not being achieved and at times even erroneous and counterproductive outcome.

Moreover, current technical solutions don't provide guidance to a supervisor or a manager to find the right balance of an expected percentage increase in agent Key Performance indicator (KPI) and a probable duration required for a challenge to achieve it.

Accordingly, there is a need for a technical solution to provide guidance about an expected percentage increase of an agent KPI performance over a duration based on past completed challenges and guidance as to how the supervisor or manager can engage and motivate the agents through achievable gamification challenges and rewards.

There is a need for a technical solution for a recommendation engine in a gamification application that would facilitate configuration of effective gamification challenges.

### SUMMARY

There is thus provided, in accordance with some embodiments of the present disclosure, a computerized-method for operating an effective cloud-based gamification application pursuit.

Furthermore, in accordance with some embodiments of the present disclosure, in a cloud-computing environment that may include a plurality of tenants, a cloud-based gamification application, a data store of pursuit-data, and a database of pursuit-templates, the cloud-based gamification application may be associated with each on-premise Performance Management (PM) application of each tenant and may operate a pursuit module.

Furthermore, in accordance with some embodiments of the present disclosure, the pursuit module may include: (a) receiving pursuit-data. The pursuit-data comprising: (i) entity; (ii) duration to complete a pursuit; (iii) Key Performance Indicator (KPI) performance metric; (iv) expected percentage increase in the KPI performance metric; (b) operating a pursuit-microservice to retrieve data from a data store associated to the on-premise PM application of the tenant and store it in the data store of pursuit-data. The data may include: (i) current KPI performance metrics of the entity; and (ii) one or more attributes of the entity; and (c) operating a recommendation engine. The entity may be an agent or a team of agents.

Furthermore, in accordance with some embodiments of the present disclosure, the pursuit module may operate the recommendation engine to: (i) operate machine learning models stored in a first cloud-object-storage to predict a difficulty-level and a pursuit-type based on the received pursuit-data and the retrieved data; (ii) retrieve from the database of pursuit-templates one or more pursuit-templates and a related score of each pursuit-template, based on the predicted difficulty level and pursuit type; and (iii) select from the one or more retrieved pursuit-templates a pursuit-template and schedule the selected pursuit-template for the entity, based on the related score.

Furthermore, in accordance with some embodiments of the present disclosure, a scheduled job periodically may update the related score of each pursuit-template in the database of pursuit-templates by: (i) retrieving participants-feedbacks as to the difficulty-level and pursuit-type of each completed-pursuit which has been created from the pursuit-template, during a preconfigured period; (ii) retrieving currently configured difficulty-level and pursuit-type of the pursuit-template; (iii) comparing each participant feedback of the participants-feedbacks, as to the difficulty-level and pursuit-type of the completed pursuit which has been created from the pursuit-template to currently configured difficulty-level and pursuit-type of the pursuit-template related to the completed-pursuit; and (iv) calculating the related score of the pursuit-template based on the comparison.

Furthermore, in accordance with some embodiments of the present disclosure, the machine learning models may be built and periodically trained based on pursuit-data and the one or more attributes of each entity and participants-feedback related to pursuit-type and difficulty-level of each completed-pursuit which may be periodically retrieved from the data store associated to the on-premise PM application of each tenant in the plurality of tenants and processed by a scheduled job, to be stored in a second cloud-object-storage. The periodically trained machine-learning models and the related accuracy score may be exported to the first cloud-object-storage.

Furthermore, in accordance with some embodiments of the present disclosure, the receiving of pursuit-data may be operated by enabling a user to access the cloud-based gamification application via the on-premise PM application to schedule a pursuit. The user may be a manager or a supervisor.

Furthermore, in accordance with some embodiments of the present disclosure, the one or more attributes of the entity may be selected from at least one of: (i) tenure; (ii) business vertical; and (iii) location.

Furthermore, in accordance with some embodiments of the present disclosure, the pursuit type may be selected from at least one of: (i) motivating; (ii) challenging; (iii) engaging; and (iv) rewarding.

Furthermore, in accordance with some embodiments of the present disclosure, the difficulty-level may be selected from at least one of: (i) easy; (ii) moderate; (iii) hard.

Furthermore, in accordance with some embodiments of the present disclosure, when the user does not enter the pursuit type and the difficulty level, the pursuit-type and the difficulty-level may be predicted by the recommendation engine and presented to the user via a User Interface (UI) of the cloud-based gamification application.

Furthermore, in accordance with some embodiments of the present disclosure, the recommendation engine may operate a first machine learning model to predict the pursuit-type and a second machine learning model to predict the difficulty-level.

Furthermore, in accordance with some embodiments of the present disclosure, after the pursuit-type and the difficulty-level are presented to the user, the user may be enabled to: (i) select via the UI of the cloud-based gamification application a pursuit-template from a list of pursuit-templates; or (ii) realign the pursuit-data. The list of pursuit-templates may be retrieved based on the pursuit-type and the difficulty-level. Each pursuit-template of the list of pursuit-templates may be presented with a related score.

Furthermore, in accordance with some embodiments of the present disclosure, the scheduled job is implemented by an Amazon Lambda job.

Furthermore, in accordance with some embodiments of the present disclosure, the first cloud-object-storage and the second cloud-object-storage may be implemented by an Amazon S3 bucket.

Furthermore, in accordance with some embodiments of the present disclosure, each participant of a completed pursuit provides a feedback and the participants-feedback may include at least one of: (i) feedback as to difficulty-level; and (ii) feedback as to pursuit-type.

Furthermore, in accordance with some embodiments of the present disclosure, the recommendation engine may expose an Application Programming Interface (API) to retrieve the one or more pursuit-templates. The API may be selected from: (i) Representational State Transfer (REST) API; or (ii) Simple Object Access Protocol (SOAP) API.

Furthermore, in accordance with some embodiments of the present disclosure, the recommendation engine may present the predicted difficulty-level and the pursuit-type to a user via User Interface (UI), by exposing an Application Programming Interface (API) to return difficulty-level and the pursuit-type.

Furthermore, in accordance with some embodiments of the present disclosure, the machine-learning models and their accuracy score may be dumped as pickle files in the first cloud-object-storage. The pickle files may be deployed by using a web application framework or a cloud machine-learning platform. The web application framework may be Flask and the cloud machine-learning platform may be Amazon Web Service (AWS) SageMaker.

Furthermore, in accordance with some embodiments of the present disclosure, the data store of pursuit-data associated with the pursuit microservice may be implemented by an Amazon Relational Database Service (RDS).

Furthermore, in accordance with some embodiments of the present disclosure, the duration to complete the pursuit may be a range of duration to complete the pursuit and the expected percentage increase in the performance of the KPI may be a range of expected increase in the performance of the KPI.

### BRIEF DESCRIPTION OF THE DRAWINGS

FIGS. 1A-1B schematically illustrate a high-level diagram of a system for operating an effective cloud-based gamification application pursuit, in accordance with some embodiments of the present disclosure;

FIG. 2 is a high-level workflow of a pursuit module, in accordance with some embodiments of the present disclosure;

FIG. 3 is a diagram of pursuit-data and related operations, in accordance with some embodiments of the present disclosure;

FIG. 4 schematically illustrates a high-level diagram of an implementation of a system for operating an effective cloud-based gamification application pursuit, in accordance with some embodiments of the present disclosure;

FIGS. 5A-5B illustrate screenshots of difficulty-level and pursuit-type related to pursuit-data presented to a user via User Interface (UI) and options to schedule a pursuit-template, in accordance with some embodiments of the present disclosure;

FIGS. 6A-6B are high-level workflows of a pursuit module, in accordance with some embodiments of the present disclosure; and

FIGS. 7A-7B are high-level workflow of machine learning training and export, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “EC2” as used herein refers to Amazon Elastic Compute Cloud (EC2) which is a part of Amazon cloud-computing platform, Amazon Web Services (AWS), that allows users to rent virtual computers on which to run their own computer applications. EC2 encourages scalable deployment of applications by providing a web service through which a user can boot an Amazon Machine Image (AMI) to configure a virtual machine, which Amazon calls an “instance”, containing any software desired. A user can create, launch, and terminate server-instances as needed, paying by the second for active servers—hence the term “elastic”.

The term “KPI performance metrics” as used herein refers to agent or team performance measurement, such as Customer Satisfaction (CSAT), First Response Time (FRT), Average Handling Time (AHT), Average Speed of Answer (ASA), Average Talk Time (ATT) evaluation score, agent sentiments, customer sentiments, and the like.

The term “pursuit” as used herein is a gamification challenge which may be a challenge to achieve a KPI target, such as to improve the score of First Call Resolution (FCR) or Average handling time (AHT) by a specified percentage. The pursuit may be scheduled for an agent or a team of agents via a gamification application and may carry rewards upon goals achievement.

In current work from home setting or hybrid scenario, supervisors and managers are looking for effective ways to manage their activities to keep workforce motivated and engaged and to keep attrition rate under control. Commonly, a user configures a challenge in a gamification application, merely based on experience, which could sometimes result in a purpose not being achieved.

Accordingly, there is a need for a technical solution to provide an effective, valuable and achievable gamification challenges for a defined duration to keep agents engaged and highly motivated using rewards and to reduce the efforts spent in configuring an effective gamification challenge. There is a need for method and system for operating an effective cloud-based gamification application pursuit.

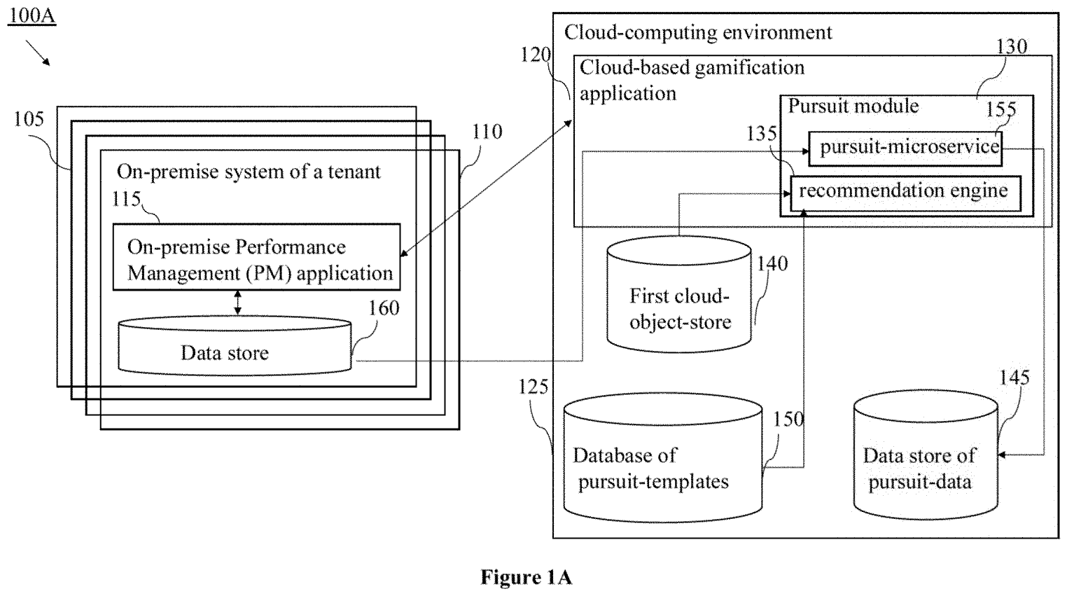

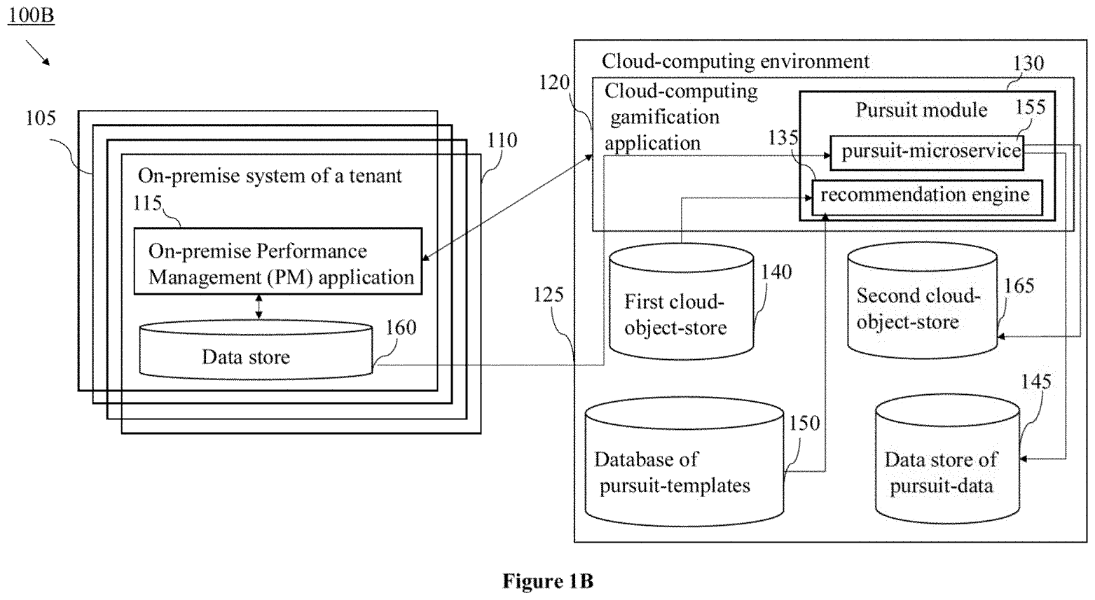

FIG. 1A schematically illustrates a high-level diagram of a system 100A for operating an effective cloud-based gamification application pursuit, in accordance with some embodiments of the present disclosure.

According to some embodiments of the present disclosure, the system 100 may include a cloud-computing environment, such as cloud-based environment 125 that may provide service to a plurality of tenants each having an on-premise system 110. The cloud-based environment 125 may include: a cloud-based gamification application 120, a data store of pursuit-data 145, and a database of pursuit-templates 150. The on-premise system of each tenant may include an on-premise Performance Management (PM) application 115 and an associated data store 160.

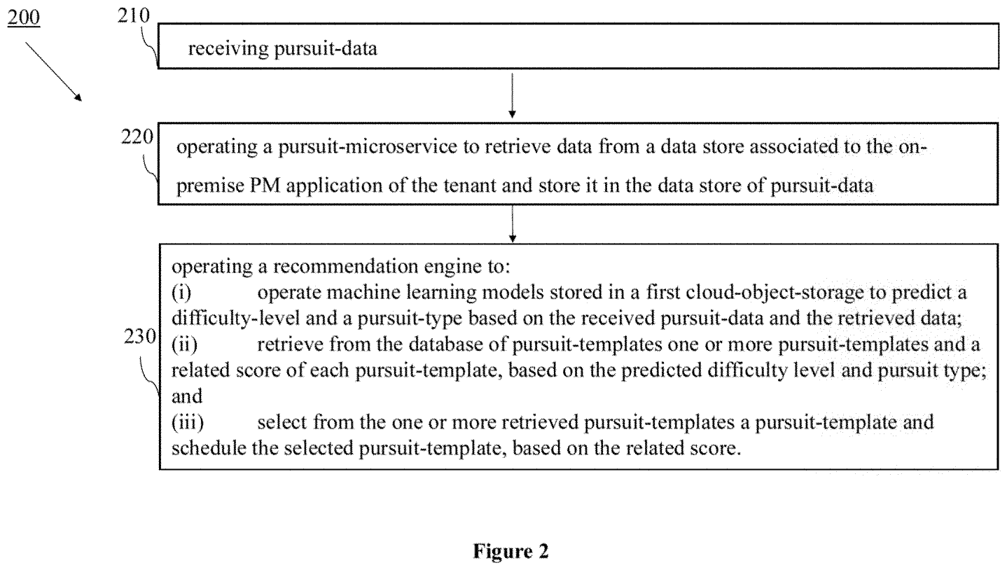

According to some embodiments of the present disclosure, the cloud-based gamification application 120 may be associated with each on-premise Performance Management (PM) application of each tenant 105 and may operate a module, such as pursuit module 130 and such as pursuit module 200 in FIG. 2.

According to some embodiments of the present disclosure, the pursuit module 130 may include: (a) receiving pursuit-data; (b) operating a pursuit-microservice 155 to retrieve data from a data store 160 associated to the on-premise PM application of the tenant 110 and store it in the data store of pursuit-data 145; and (c) operating a recommendation engine 135. The recommendation engine 135 may be a Flask based web application and may be operated to predict difficulty-level and pursuit-type of a pursuit to be automatically scheduled based on received pursuit-data. The automatically scheduled pursuit may be selected from a list of scored pursuit templates based on the predicted difficulty-level and pursuit-type and related score. The recommendation engine 135 may be common for all tenants in the cloud-computing environment 125. This score of the pursuit-template may be used to indicate whether the feedback received from participants aligns with the difficulty-level and pursuit-type of the pursuit-template. The pursuit-template may be in Java Script Object Notation (JSON) format.

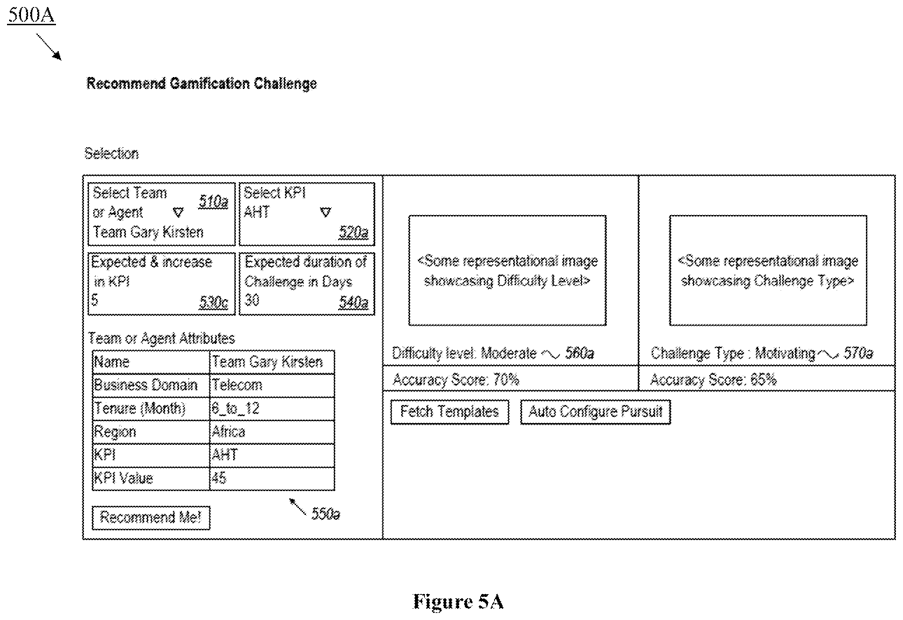

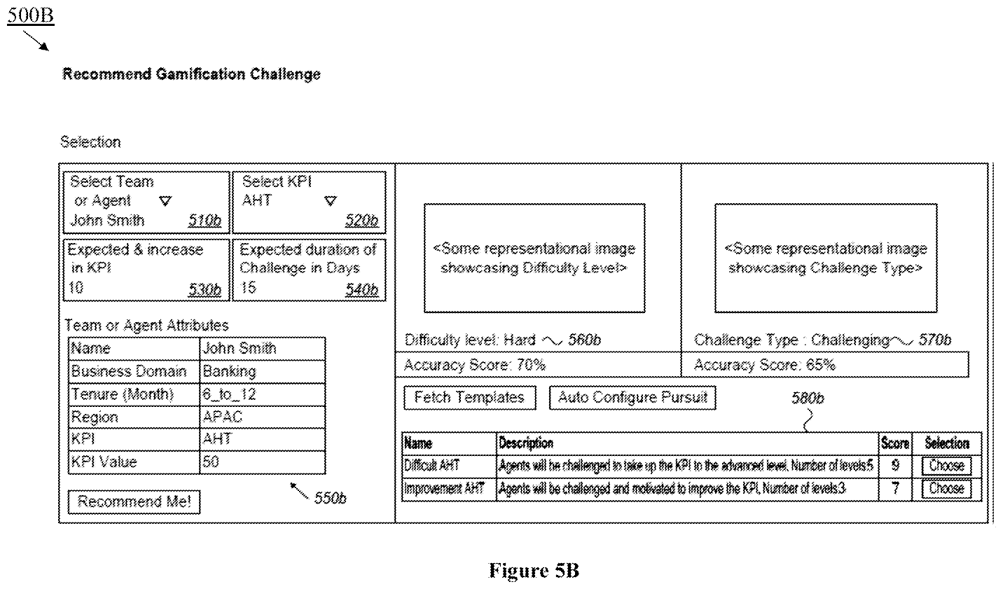

According to some embodiments of the present disclosure, optionally, the recommendation engine 135 may be operated to predict difficulty-level and pursuit-type of a pursuit, after a user, such as a manager or a supervisor, has entered via a User Interface (UI) which is associated to the cloud-based gamification application 120. The predicted difficulty-level and pursuit-type may be presented to the user, as shown in FIG. 5A.

According to some embodiments of the present disclosure, after the pursuit-type and the difficulty-level may be presented to the user via the UI associated to the cloud-based gamification application 120, the user may be enabled to: (i) select via the UI of the gamification application a pursuit-template from a list of pursuit-templates; or (ii) realign the pursuit-data.

According to some embodiments of the present disclosure, the list of pursuit-templates may be a list of scored pursuit-template which may be configured to have the predicted difficulty-level and pursuit-type and the related score of each pursuit-template may be based on participants feedback of completed pursuits which were scheduled based on the pursuit-template.

According to some embodiments of the present disclosure, the pursuit-data may be received by a batch process or by enabling a user to access the cloud-based gamification application 120 via the on-premise PM application 115 to schedule a pursuit, as shown in FIGS. 5A-5B. The user may be a manager or a supervisor in the contact center. The pursuit-data may include: (i) entity; (ii) duration to complete a pursuit; (iii) Key Performance Indicator (KPI) performance metric; and (iv) expected percentage increase in the KPI performance metric. The entity may be an agent or a team of agents. When a team is selected, the tenure and KPI value may be the average values for the team that is selected.

According to some embodiments of the present disclosure, a user may realign the pursuit-data when the predicted difficulty-level and pursuit-type may not be satisfactory. For example, when the user has entered KPI performance metric, such as Average Handling Time (AHT) and the expected percentage increase in the KPI performance metric from the entity after the pursuit is scheduled that the user has entered is 10% for a duration to complete the pursuit of 15 days and the predicted difficulty-level presented to the user may be ‘hard’ and the pursuit-type may be ‘challenging’ then the user may realign the pursuit-data, such as change the expected percentage increase in the KPI performance metric or the duration to complete the pursuit to pursuit-templates that are ‘moderate’ and ‘motivating’ by entering expected percentage increase in the KPI performance metric lower than 10% or by increasing the duration to complete the pursuit to more than 15 days.

According to some embodiments of the present disclosure, the duration to complete the pursuit may be a range of duration to complete the pursuit and the expected percentage increase in the performance of the KPI may be a range of expected increase in the performance of the KPI. For example, the duration to complete the pursuit may be 10-15 days and the expected percentage increase in the performance of the KPI may be 8%-10%.

According to some embodiments of the present disclosure, when the user may be satisfied with the predicted difficulty-level and the pursuit-type the user may be enabled to select via the UI of the gamification application a pursuit-template from a list of pursuit-templates, as shown in screenshot of difficulty-level and pursuit-type related to pursuit-data presented to a user via User Interface (UI) and options to schedule a pursuit-template 500B, in FIG. 5B.

According to some embodiments of the present disclosure, when the user does not enter the pursuit-type and the difficulty-level, e.g., a batch process, the pursuit-type and the difficulty-level may be predicted by the recommendation engine 135 and presented to the user via a User Interface (UI) of the cloud-based gamification application.

According to some embodiments of the present disclosure, the retrieved data by the pursuit-microservice 155, may include: (i) current KPI performance metrics of the entity; and (ii) one or more attributes of the entity. The selected pursuit-template may be scheduled for the entity which has been included in the pursuit-data. The one or more attributes of the entity may be selected from at least one of: (i) tenure; (ii) business vertical; and (iii) location. For example, tenure of the agent may be the number of years the agent has worked in the contact center or the tenure of the team of agents may be the average of the years of the agents in the team. The business vertical may be banking, tourism, telecom and the like. The location may be a city, a state or a continent.

According to some embodiments of the present disclosure, the pursuit-microservice 155 may be hosted in an Amazon Elastic Compute Cloud (EC2). The data store of pursuit-data 145 associated with the pursuit microservice may be implemented by an Amazon Relational Database Service (RDS).

According to some embodiments of the present disclosure, the recommendation engine 135 may operate machine learning models stored in a first cloud-object-storage to predict a difficulty-level and a pursuit-type based on the received pursuit-data and the retrieved data. A first machine learning model may be operated to predict the pursuit-type and a second machine learning model may be operated to predict the difficulty-level.

According to some embodiments of the present disclosure, the machine learning models for the recommendation engine may be periodically trained by leveraging the historical completed challenge data from multiple tenants in the cloud. The dataset used for training the machine learning models may comprise data of participants challenge completion as well as participants feedback on their completed challenges. This data will be aggregated from all tenants in the cloud-computing environment along with a consent of data usage from the tenants.

According to some embodiments of the present disclosure, the recommendation engine 135 may further retrieve from the database of pursuit-templates one or more pursuit-templates and a related score of each pursuit-template, based on the predicted difficulty level and pursuit type and select from the one or more retrieved pursuit-templates a pursuit-template and automatically schedule the selected pursuit-template, based on the highest related score.

According to some embodiments of the present disclosure, the pursuit-type may be (i) motivating; (ii) challenging; (iii) engaging; and (iv) rewarding. The difficulty-level may be (i) easy; (ii) moderate; (iii) hard.

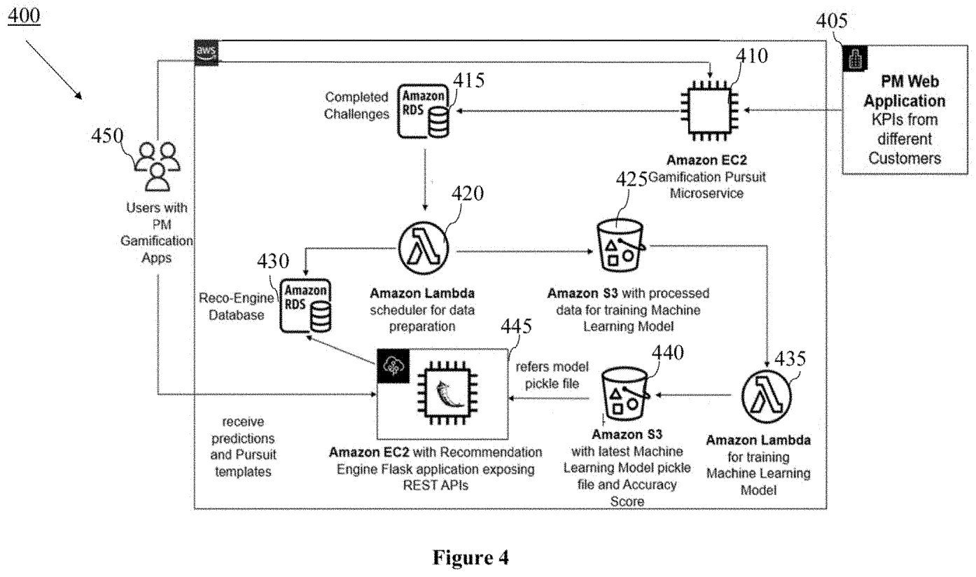

According to some embodiments of the present disclosure, a scheduled job, such as scheduled job 420 in FIG. 4, may periodically update the related score of each pursuit-template in the database of pursuit-templates 150 by: (i) retrieving participants-feedbacks as to the difficulty-level and pursuit-type of a completed-pursuit which has been created from the pursuit-template, during a preconfigured period; (ii) retrieving currently configured difficulty-level and pursuit-type of the pursuit-template; (iii) comparing each participant feedback of the participants-feedbacks as to the difficulty-level and pursuit-type of the completed pursuit which has been created from the pursuit-template to currently configured difficulty-level and pursuit-type of the pursuit-template related to the completed-pursuit; and (iv) calculating the related score of the pursuit-template based on the comparison.

According to some embodiments of the present disclosure, each participant of a completed pursuit may provide a feedback. The participants-feedback may include at least one of: (i) feedback as to difficulty-level; and (ii) feedback as to pursuit-type. The feedback may be collected from all completed pursuit participants. This feedback may be used to periodically train the machine learning models in general, and moreover, if the feedback is received for a pursuit that was created from a pursuit template then that feedback may be used to fine-tune the score of the corresponding pursuit template.

According to some embodiments of the present disclosure, for example, a pursuit-template which may be configured as difficulty-level ‘hard’ and pursuit-type ‘challenging’ may be scheduled to one or more agents and may receive from each participant a feedback upon completion.

According to some embodiments of the present disclosure, the scale on which a score of a pursuit-template may be calculated is from 1-10.

According to some embodiments of the present disclosure, based on the combinations of pursuit-type and difficulty-level related feedback, a score may be assigned to the pursuit templates. For example, for pursuit-template which has been chosen for ‘Motivating’ pursuit-type and ‘easy’ difficulty-level and agent provided a feedback as ‘Challenging’ pursuit-type and ‘Hard’ difficulty-level then the score of ‘1’ may be assigned to the pursuit-template.

According to some embodiments of the present disclosure, in another example, when an agent gives a feedback for a pursuit that has been created from a pursuit-template, then, if the feedback matches on the pursuit-type and the difficulty-level then the respective pursuit-template is given the highest score ‘10’. Similarly, if only pursuit-type is matching then a score of ‘7’ may be assigned, whereas if only difficulty-level is matching then a score of ‘5’ may be assigned.

According to some embodiments of the present disclosure, the score configuration may be changed based on the tenant requirements. A score received against the pursuit-template may be averaged based on the score which is currently configured for the pursuit-template. For example, if the pursuit template existing score is ‘8’ for total 9 feedbacks which were received and based on the incoming feedback from above example, the score of ‘1’ may be considered, then the final score of pursuit template may be (8*9+1)/(9+1)=7.3.

FIG. 1B schematically illustrates a high-level diagram of a system 100B for operating an effective cloud-based gamification application pursuit, in accordance with some embodiments of the present disclosure.

According to some embodiments of the present disclosure, a system, such as system 100B may have the same components as system 100A. A cloud-computing environment 125 that may include a plurality of tenants, a cloud-based gamification application 120, a data store of pursuit-data 145, and a database of pursuit-templates 150. The cloud-based gamification application 120 may be associated with each on-premise Performance Management (PM) application 110 of each tenant and operating a pursuit module 130.

According to some embodiments of the present disclosure, the recommendation engine 135 may operate machine learning models stored in a first cloud-object-storage 140 to predict a difficulty-level and a pursuit-type based on the received pursuit-data and the retrieved data. The recommendation engine 135 may be associated with a recommendation engine database.

According to some embodiments of the present disclosure, the machine learning models may be built and periodically trained based on pursuit-data and the one or more attributes of each entity and participants-feedback related to pursuit-type and difficulty-level of each completed-pursuit which are periodically retrieved from the data store associated to the on-premise PM application of each tenant 160 in the plurality of tenants and processed by a scheduled job, to be stored in a second cloud-object-storage 165. The periodically trained machine-learning models and the related accuracy score may be exported to the first cloud-object-storage 140.

According to some embodiments of the present disclosure, the scheduled job may be implemented by an Amazon Lambda job.

According to some embodiments of the present disclosure, the first cloud-object-storage and the second cloud-object-storage are implemented by an Amazon S3 bucket.

According to some embodiments of the present disclosure, the recommendation engine 135 may expose an Application Programming Interface (API) to retrieve the one or more pursuit-templates. The API is selected from: (i) Representational State Transfer (REST) API; or (ii) Simple Object Access Protocol (SOAP) API.

Furthermore, in accordance with some embodiments of the present disclosure, the recommendation engine 135 may present the predicted difficulty-level and the pursuit-type to a user via User Interface (UI) e.g., as shown in FIGS. 5A-5B, by exposing an Application Programming Interface (API) to return difficulty-level and the pursuit-type.

According to some embodiments of the present disclosure, the process of exposing REST API to return the pursuit-templates and their related scores based on the difficulty-level and pursuit-type and KPI name as sent in a request may comprise: (a) when receiving a request, gathering the relevant parameters from the request; (b) querying the recommendation engine database based on the request parameters to get the applicable pursuit-templates and related scores; and (c) preparing a response structure with a list of relevant pursuit-template structures and related scores.

According to some embodiments of the present disclosure, the process of exposing REST API to return a response of the difficulty-level and pursuit-type based on a request comprised of KPI name, business vertical, agent tenure, current KPI score and target percentage increase in KPI score may comprise: (a) when receiving a request, the request may be transformed into the corresponding One-Hot encoded variables for the categorical features KPI, business vertical, and agent tenure; (b) getting the prediction from the models for difficulty-level and pursuit-type for the request received; and (c) converting the predictions and accuracy scores into the a response structure and returning the response.

According to some embodiments of the present disclosure, the machine-learning models and their accuracy score may be dumped as pickle files in the first cloud-object-storage 140. The pickle files may be deployed by using a web application framework or a cloud machine-learning platform. The web application framework may be Flask and the cloud machine-learning platform may be Amazon Web Service (AWS) SageMaker.

FIG. 2 is a high-level workflow of a pursuit module 200, in accordance with some embodiments of the present disclosure.

According to some embodiments of the present disclosure, operation 210 comprising receiving pursuit-data.

According to some embodiments of the present disclosure, the received pursuit-data may include: (i) entity; (ii) duration to complete a pursuit; (iii) Key Performance Indicator (KPI) performance metric; (iv) expected percentage increase in the KPI performance metric.

According to some embodiments of the present disclosure, the entity may be an agent or a team of agents, which later on may be scheduled a pursuit-template.

According to some embodiments of the present disclosure, operation 220 comprising operating a pursuit-microservice to retrieve data from a data store associated to the on-premise PM application of the tenant and store it in the data store of pursuit-data.

According to some embodiments of the present disclosure, the retrieved data may include: (i) current KPI performance metrics of the entity; and (ii) one or more attributes of the entity. The selected pursuit-template is scheduled for the entity.

According to some embodiments of the present disclosure, operation 230 comprising operating a recommendation engine to: (i) operate machine learning models stored in a first cloud-object-storage to predict a difficulty-level and a pursuit-type based on the received pursuit-data and the retrieved data; (ii) retrieve from the database of pursuit-templates one or more pursuit-templates and a related score of each pursuit-template, based on the predicted difficulty level and pursuit type; and (iii) select from the one or more retrieved pursuit-templates a pursuit-template and schedule the selected pursuit-template, based on the related score.

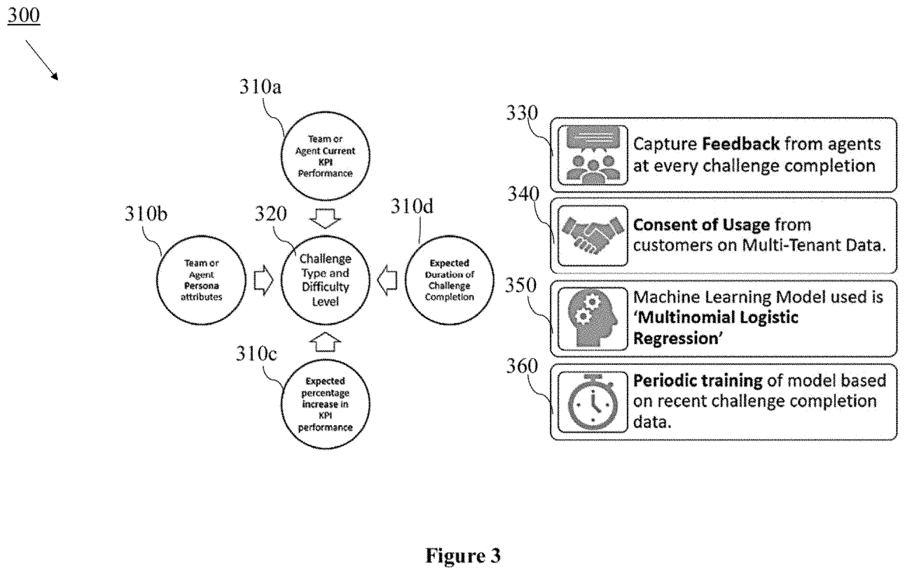

FIG. 3 is a diagram 300 of pursuit-data and related operations, in accordance with some embodiments of the present disclosure.

According to some embodiments of the present disclosure, the pursuit-data may include the entity, e.g., team or agent, the team or agent current KPI performance 310a, the Key Performance Indicator (KPI) performance metric, such as Average Handling Time (AHT), Click-To-Talk (CTT), Non Speech Time (NST) and the like and the expected percentage increase in the KPI performance metric 310c and the duration to complete a pursuit, e.g., the expected duration of challenge completion 310d.

According to some embodiments of the present disclosure, based on the pursuit-data and the retrieved data which may include the current KPI performance metrics of the entity and one or more attributes of the entity, the team or agent persona attributes 310b, such as (i) tenure; (ii) business vertical; and (iii) location, the selected pursuit-template may be scheduled for the entity.

According to some embodiments of the present disclosure, a feedback as to the difficulty-level and pursuit-type may be captured from agents at every challenge, e.g., pursuit completion. Each tenant of the cloud-computing environment, such as cloud-computing environment 125 in FIGS. 1A-1B, may provide a consent of usage as to pursuit-data and data retrieved from the tenant's data store such as the data store that is associated to the on-premise PM application 115 in FIGS. 1A-1B.

According to some embodiments of the present disclosure, the machine learning models that a recommendation engine, such as recommendation engine 135 in FIGS. 1A-1B may operate, may be multinomial logistics regression 350. Multinomial logistic regression is a classification method that generalizes logistic regression to more than two possible discrete outcomes, i.e. multiple classes. A multinomial logistic regression model may be used to predict the probabilities of the different possible outcomes of a categorically distributed dependent variable, given a set of independent variables, which may be real-valued, binary-valued, categorical-valued, etc., by using maximum likelihood estimation to evaluate the probability of categorical membership.

According to some embodiments of the present disclosure, the machine learning models may be periodically trained based on recent challenge completion data 360. For example, participants may provide feedback as to difficulty-level and pursuit-type of a completed pursuit which has been scheduled base on a pursuit-template. The participants feedback may be compared to the difficulty-level and pursuit-type which are currently configured to the pursuit-template.

FIG. 4 schematically illustrates a high-level diagram 400 of an implementation of a system for operating an effective cloud-based gamification application pursuit, in accordance with some embodiments of the present disclosure.

According to some embodiments of the present disclosure, a pursuit may be automatically scheduled from a cloud-based gamification application, such as cloud-based gamification application 120 in FIGS. 1A-1B or a user may enter pursuit-data to the cloud-based gamification application via a PM web application 405 such as on-premise PM application 115, in FIGS. 1A-1B. The current KPIs and entity attributes of the agents and teams may be presented via a UI associated with the PM web application. The KPIs of the agents and teams participating in a pursuit may be retrieved by a pursuit-microservice, such as gamification pursuit microservice 410 from the PM web application 405 and may be stored in a data store, such as data store of pursuit-data 145 in FIGS. 1A-1B, and such as Amazon Relational Database Service (RDS) 415 for current KPI scores at the start of a scheduled pursuit.

According to some embodiments of the present disclosure, a pursuit-microservice, such as the gamification pursuit-microservice 410 may be hosted in Amazon Elastic Compute Cloud (EC2). The gamification pursuit microservice 410 may include the business logic behind each pursuit or challenge, e.g., gamification challenges and may manage the data related to the pursuits. Participants of a pursuit may provide their feedback as to difficulty-level and pursuit-type once the pursuit is completed.

According to some embodiments of the present disclosure, the gamification pursuit microservice 410 may interact with a data store, such as data store of pursuit-data 145 in FIGS. 1A-1B which may be implemented by an Amazon RDS database 415 that holds the data of all gamification pursuits. The gamification pursuits may be in different states such as draft, scheduled, in-progress or completed.

According to some embodiments of the present disclosure, the Amazon RDS database 415 for the gamification pursuit microservice 410 may have the schema and data related to all the pursuits. Each tenant in the cloud-computing environment, such as cloud-computing environment 125 in FIGS. 1A-1B may have its own separate schema and data in the Amazon RDS database 415.

According to some embodiments of the present disclosure, completed pursuit related data may be periodically retrieved by a scheduled job 420 from the Amazon RDS database 415 for different tenants. The scheduled job 420 may be based on Amazon Lambda and may refer to the recently completed pursuit related data from the Amazon RDS database 415 for various tenants the cloud-computing environment and may have logic for data consolidation, data masking and data preparation.

According to some embodiments of the present disclosure, the scheduled job 420 may be configured to refine the scores of the pursuit templates in the recommendation engine database 430 when the completed pursuit was created using the pursuit template. This will ensure that the pursuit templates scores keep getting updated in the recommendation engine database 430 based on the feedback given by the participants of the pursuits that were created using the pursuit templates. This scheduled job 420 may also be implemented using Amazon Batch. Amazon Batch is a service which could be an alternative to the Amazon Lambda job, and it is typically used for longer running jobs/processes.

According to some embodiments of the present disclosure, the data prepared by the scheduled job 420 may be stored in a cloud object storage, such as second cloud-object-storage 165 in FIG. 1B and may be implemented in an Amazon S3 bucket 425. The Amazon S3 bucket 425 may store the data prepared and processed by the scheduled job 420. This data may be used by a scheduled job 435 based on Amazon Lambda that will train the machine learning models.

According to some embodiments of the present disclosure, the scheduled job 420 may also be configured to refine the scores of the pursuit templates in the recommendation engine database 430 when the completed pursuit was created using the pursuit template.

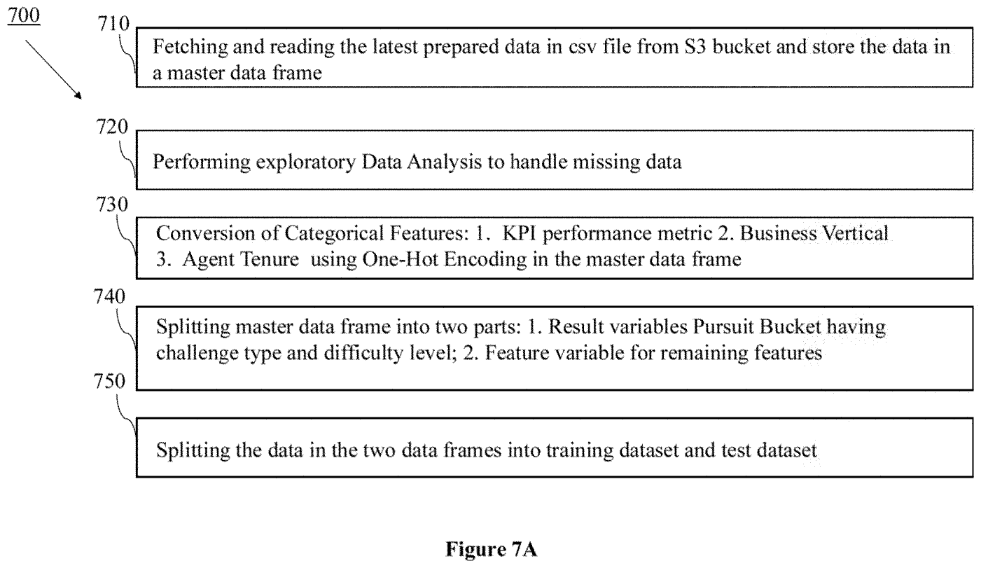

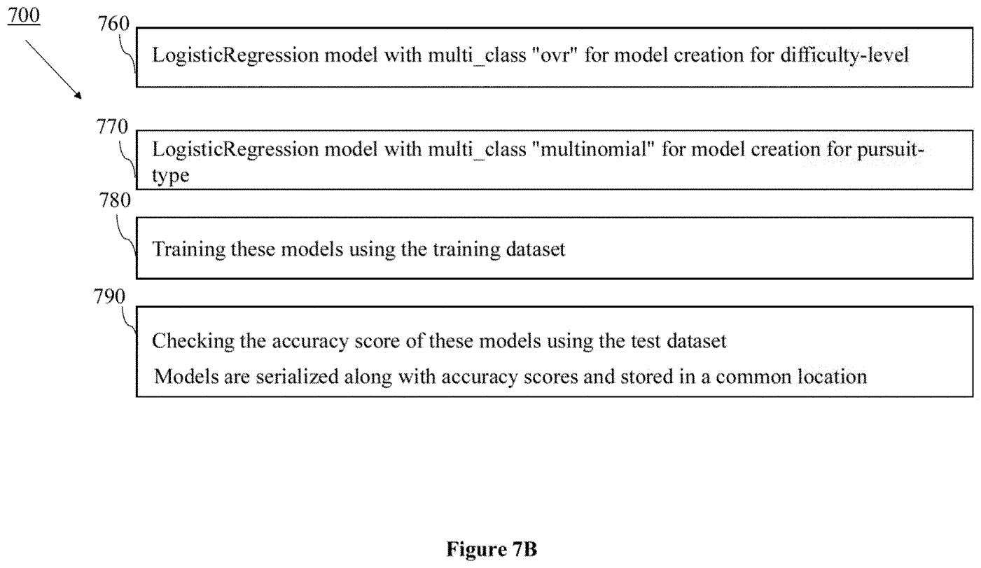

According to some embodiments of the present disclosure, the scheduled job 435 based on Amazon Lambda that will train the machine learning models by referring to the data stored in a cloud object storage, such as second cloud-object-storage 165 in FIG. 1B and may be implemented in an Amazon S3 bucket 425. The scheduled job 435 may be triggered periodically to train the machine learning models in regular intervals based on the recent data consolidated and prepared by the scheduled job 420 and stored in Amazon S3 bucket 425, as described in detail in FIGS. 7A-7B.

According to some embodiments of the present disclosure, once the machine learning models are trained by the scheduled job 435, they may be exported as pickle files and stored along with their respective accuracy scores in a cloud object storage, such as first cloud-object-storage 140 in FIG. 1B and may be implemented in an Amazon S3 bucket 440.

According to some embodiments of the present disclosure, the cloud object storage, such as first cloud-object-storage 140 in FIG. 1B and may be implemented in an Amazon S3 bucket 440 may store the latest machine learning model pickle files which were generated by the scheduled job 435 and their corresponding accuracy scores. The latest machine learning model pickle files may be referred by a recommendation engine, such as recommendation engine 135 in FIGS. 1A-1B and such as the recommendation engine Flask application 445, hosted in Amazon EC2.

According to some embodiments of the present disclosure, the recommendation engine Flask application 445 may refer to the latest machine learning model pickle files and their accuracy scores from a cloud object storage, such as first cloud-object-storage 140 in FIG. 1B and may be implemented in an Amazon S3 bucket 440. The recommendation engine Flask application 445 may expose Representational State Transfer (REST) end-point to get predictions or insights based on the machine learning models.

According to some embodiments of the present disclosure, the recommendation engine Flask application 445 may also expose REST end-point to fetch pursuit templates that can be used as baseline to configure pursuits. The recommendation engine Flask application 445 may be hosted in Amazon EC2 using Amazon Elastic Beanstalk.

According to some embodiments of the present disclosure, the recommendation engine Flask application 445 may fetch the pickle files for the machine learning models for difficulty-level and pursuit-type and their respective accuracy scores from S3 bucket 440 and load them to be available in the FLASK application. Then, the recommendation engine Flask application 445 may expose a REST API to return the difficulty-level and pursuit-type based on the request comprised of KPI performance metric, business domain, e.g., business vertical, agent tenure, current KPI score and the expected percentage increase in the KPI performance metric and expected duration of challenge completion. A REST API (also known as RESTful API) is an application programming interface (API or web API) that conforms to the constraints of REST architectural style and allows for interaction with RESTful web services.

According to some embodiments of the present disclosure, the recommendation engine Flask application 445 may expose a REST API to return the difficulty-level and pursuit-type by: receiving a request, e.g., pursuit-data and transforming it into a corresponding one-hot encoded variables for the categorical features KPI, business domain, and agent tenure. Then, get the prediction from the machine learning models for difficulty-level and pursuit-type for the request received and convert the predictions and accuracy scores into the desired response structure and return the response.

According to some embodiments of the present disclosure, the recommendation engine Flask application 445 may expose a REST API to return the pursuit-templates and their scores based on the difficulty-level and pursuit-type and KPI performance metric as sent in request. On receiving a request, e.g., pursuit-data the recommendation engine Flask application 445 may gather the relevant parameters from the request and then retrieve from the recommendation engine database 430 based on the request parameters the pursuit-templates and related scores to prepare the response structure with the list of relevant pursuit-template structures and their scores.

According to some embodiments of the present disclosure, optionally, the machine learning model could also be deployed using Amazon SageMaker.

According to some embodiments of the present disclosure, when there is a request to the REST end-point of the recommendation engine Flask application 445 to fetch the predefined pursuit-templates based on the predictions, the recommendation engine Flask application 445 may query the recommendation engine database 430 on the basis of the request parameters, i.e. KPI, pursuit-type and difficulty-level to get the applicable pursuit-templates with their scores.

According to some embodiments of the present disclosure, recommendation engine database 430 for the recommendation engine Flask application 445 may hold the predefined pursuit-templates corresponding to the pursuit-data e.g., different KPIs, difficulty-level and pursuit-type. The scores associated with the pursuit-templates may also be persisted which may be periodically refined the scheduled job 420.

According to some embodiments of the present disclosure, predictions or insights may be received on demand by invoking the REST end-point exposed by the recommendation engine Flask application 445. Pursuit-templates may be also received based on the predictions by invoking REST end-point exposed by the recommendation engine Flask application 445.

According to some embodiments of the present disclosure, end users 450, such as managers or supervisors may enter pursuit-data to the cloud-based gamification application via a PM web application 405 such as on-premise PM application 115, in FIGS. 1A-1B. The cloud-based gamification application may interact with the pursuit-microservice, such as gamification pursuit microservice 410.

FIGS. 5A-5B illustrate screenshots of difficulty-level and pursuit-type related to pursuit-data presented to a user via User Interface (UI) and options to schedule a pursuit-template, in accordance with some embodiments of the present disclosure.

According to some embodiments of the present disclosure, in screenshot 500A, for an entered entity may be the team ‘Gary Kristen’ 510a and the entered KPI may be AHT 520a, based on the team persona or attributes 550a, a user, such as a manager or a supervisor may enter an expected percentage increase in KPI 530c e.g. 5% and an expected duration of challenge in days 540a, e.g., 30 days. Based on the pursuit-data and data retrieved by a pursuit microservice, such as pursuit-microservice 155 in FIGS. 1A-1B, the recommendation engine, such as recommendation engine 135 in FIGS. 1A-1B may provide a prediction of pursuit of difficulty-level, ‘Moderate’ 560a and pursuit-type ‘Motivating’ 570a.

According to some embodiments of the present disclosure, in screenshot 500B, for an entered entity may be agent ‘John Smith’ 510b and the entered KPI may be AHT 520b, based on the agent persona or attributes 550b, a user, such as a manager or a supervisor may enter an expected percentage increase in KPI 530b, e.g., 10% and an expected duration of challenge in days 540b, e.g., 15 days. Based on the pursuit-data and data retrieved by the pursuit-microservice such as pursuit-microservice 155 in FIGS. 1A-1B, the recommendation engine, such as recommendation engine 135 in FIGS. 1A-1B may provide a prediction of pursuit of difficulty-level, ‘Hard’ 560b and pursuit-type ‘Challenging’ 570b.

According to some embodiments of the present disclosure, a list such as a list of pursuit-templates 580b with their score based on the KPI, difficulty-level and pursuit-type may be displayed when the manager or supervisor has clicked on “Fetch Template” button, after which the manager or supervisor may select one of those pursuit-templates to create the pursuit.

According to some embodiments of the present disclosure, optionally, a user may click on the button “Auto Configure Pursuit” to automatically select the pursuit-template with the highest score as per the difficulty-level and pursuit-type received earlier on that screen from the recommendation engine, such as recommendation engine 135 in FIGS. 1A-1B.

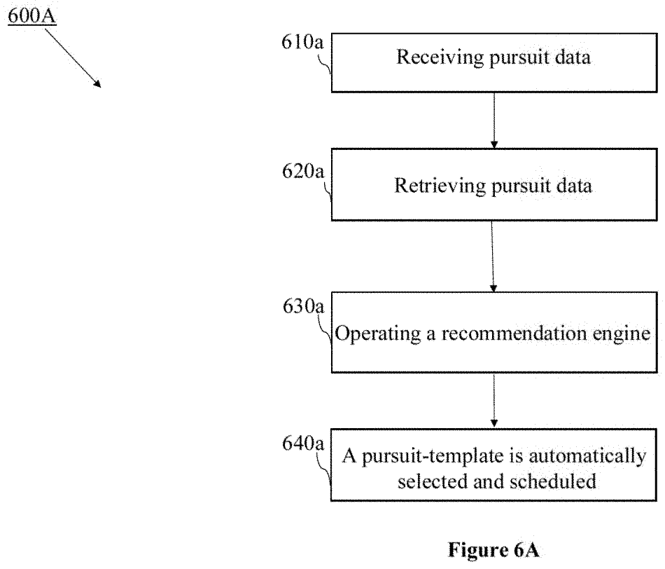

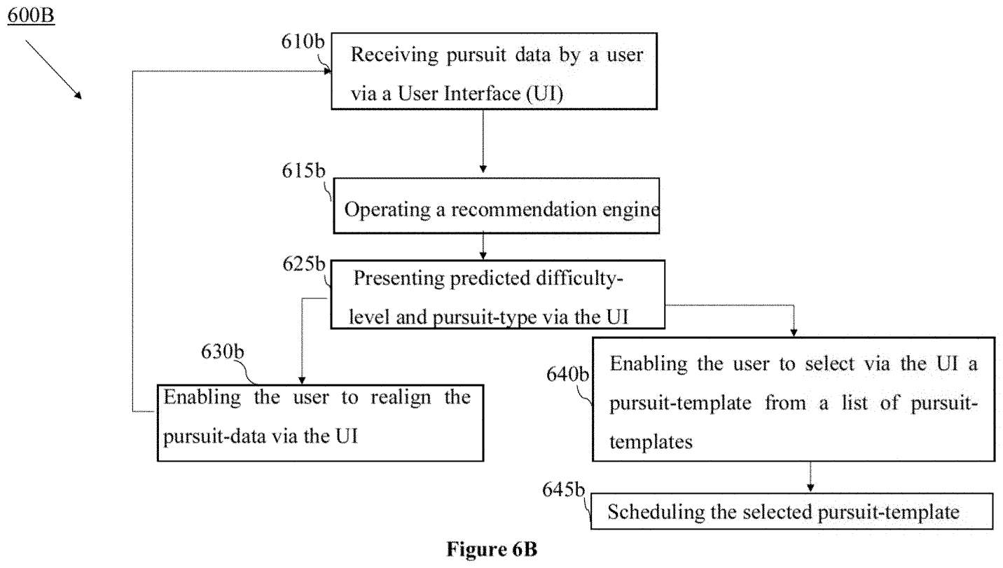

FIG. 6A is a high-level workflows of a pursuit module 600A, in accordance with some embodiments of the present disclosure.

According to some embodiments of the present disclosure, a pursuit module, such as pursuit model 600A and such as pursuit module 130 in FIGS. 1A-1B may include receiving pursuit data 610a and retrieving pursuit data 620a.

According to some embodiments of the present disclosure, the pursuit-data may include: (i) entity; (ii) duration to complete a pursuit; (iii) Key Performance Indicator (KPI) performance metric; (iv) expected percentage increase in the KPI performance metric. The retrieved data may include: (i) current KPI performance metrics of the entity; and (ii) one or more attributes of the entity. The selected pursuit-template may be scheduled for the entity.

According to some embodiments of the present disclosure, the pursuit module, such as pursuit model 600A and such as pursuit module 130 in FIGS. 1A-1B may further include operating a recommendation engine, such as recommendation engine 135 in FIGS. 1A-1B and such as recommendation engine Flask application 445 in FIG. 4.

According to some embodiments of the present disclosure, a pursuit-template may be automatically selected and scheduled 640a for the entity.

FIG. 6B is a high-level workflow of a pursuit module 600B, in accordance with some embodiments of the present disclosure.

According to some embodiments of the present disclosure, a guidance may be provided to a manager or supervisor at the time of challenge definition thereby making their work effective and easier and reducing the upscaling work to configure the challenges.

According to some embodiments of the present disclosure, the provided guidance may result in more engagement with the gamification module for deriving better results through effective challenges which will result in deeper engagement with a performance management product.

According to some embodiments of the present disclosure, a pursuit module, such as pursuit model 600B may comprise receiving pursuit-data by a user via a User Interface (UI) as shown in FIGS. 5A-5B.

According to some embodiments of the present disclosure, the pursuit module 600B may comprise operating a recommendation engine 615b, such as recommendation engine 135 in FIGS. 1A-1B and such as recommendation engine Flask application 445 in FIG. 4.

According to some embodiments of the present disclosure, the pursuit module 600B may comprise presenting predicted difficulty-level and pursuit-type via the UI 625b, as shown in FIGS. 5A-5B.

According to some embodiments of the present disclosure, the pursuit module 600B may comprise enabling the user to realign the pursuit-data via the UI 630b and enabling the user to select via the UI a pursuit-template from a list of pursuit-templates 640b.

According to some embodiments of the present disclosure, once the user has selected a pursuit-template, the pursuit module 600B may comprise scheduling the selected pursuit-template 645b for the entity specified and for the entered duration.

FIGS. 7A-7B are high-level workflow of machine learning training and export 700, in accordance with some embodiments of the present disclosure.

According to some embodiments of the present disclosure, the machine learning training and export 700 may comprise fetching and reading the latest prepared data in Comma-Separated Values (CSV) file from a data store, such as S3 bucket and store the data in a master data frame 710.

According to some embodiments of the present disclosure, then performing exploratory data analysis to handle missing data 720.

According to some embodiments of the present disclosure, the machine learning training and export 700 may operate a conversion of Categorical Features: 1. KPI performance metric; 2. Business Vertical; 3. Agent tenure using One-Hot encoding in the master data frame 730 and then, splitting master data frame into two parts: 1. result variables pursuit bucket having challenge type and difficulty level; 2. feature variable for remaining features 740. Since, machine learning algorithms receive numbers and not text for values of variables, One-Hot encoding is a common technique or process of converting the categorical data variables, i.e. categorical features, to be provided to machine learning algorithms which improves predictions, as well as classification accuracy of a model. This type of encoding creates a new binary feature for each possible category and assigns a value of 1 to the feature of each sample that corresponds to its original category.

According to some embodiments of the present disclosure, the machine learning training and export 700 may split the data in the two data frames into training dataset and test dataset 750 and operate LogisticRegression model with multi_class “ovr” for model creation for difficulty-level 760 and LogisticRegression model with multi_class “multinomial” for model creation for pursuit-type 770.

According to some embodiments of the present disclosure, the machine learning training and export 700 may train these models using the dataset 780 and check the accuracy score of these models using the test dataset, models are serialized along with accuracy scores and stored in a common location 790.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for operating an effective cloud-based gamification application pursuit, said computerized-method comprising:
in a cloud-computing environment comprising a plurality of tenants, a cloud-based gamification application, a data store of pursuit-data, and a database of pursuit-templates, said cloud-based gamification application is associated with each on-premise Performance Management (PM) application of each tenant and operating a pursuit module, said pursuit module comprising:
(a) receiving pursuit-data,
(b) operating a pursuit-microservice to retrieve data from a data store associated to the on-premise PM application of the tenant and store it in the data store of pursuit-data; and
(c) operating a recommendation engine to:
(i) operate machine learning models stored in a first cloud-object-storage to predict a difficulty-level and a pursuit-type based on the received pursuit-data and the retrieved data;
(ii) retrieve from the database of pursuit-templates one or more pursuit-templates and a related score of each pursuit-template, based on the predicted difficulty level and pursuit type; and
(iii) select from the one or more retrieved pursuit-templates a pursuit-template and schedule the selected pursuit-template, based on the related score.

2. The computerized-method of claim 1, wherein the pursuit-data comprising: (i) entity; (ii) duration to complete a pursuit; (iii) Key Performance Indicator (KPI) performance metric; (iv) expected percentage increase in the KPI performance metric, wherein the retrieved data comprising: (i) current KPI performance metrics of the entity; and (ii) one or more attributes of the entity and wherein the selected pursuit-template is scheduled for the entity.

3. The computerized-method of claim 1, wherein a scheduled job updates the related score of each pursuit-template in the database of pursuit-templates by:
(i) retrieving participants-feedbacks as to the difficulty-level and pursuit-type of a completed-pursuit which has been created from the pursuit-template, during a preconfigured period;
(ii) retrieving currently configured difficulty-level and pursuit-type of the pursuit-template;
(iii) comparing each participant feedback of the participants-feedbacks as to the difficulty-level and pursuit-type of the completed pursuit which has been created from the pursuit-template to currently configured difficulty-level and pursuit-type of the pursuit-template related to the completed-pursuit; and
(iv) calculating the related score of the pursuit-template based on the comparison.

4. The computerized-method of claim 1, wherein the machine learning models are built and periodically trained based on pursuit-data and the one or more attributes of each entity and participants-feedback related to pursuit-type and difficulty-level of each completed-pursuit which are periodically retrieved from the data store associated to the on-premise PM application of each tenant in the plurality of tenants and processed by a scheduled job, to be stored in a second cloud-object-storage,
wherein the periodically trained machine-learning models and the related accuracy score are exported to the first cloud-object-storage.

5. The computerized-method of claim 1, wherein the receiving of pursuit-data is by enabling a user to access the cloud-based gamification application via the on-premise PM application to schedule a pursuit.

6. The computerized-method of claim 1, wherein the one or more attributes of the entity are selected from at least one of: (i) tenure; (ii) business vertical; and (iii) location.

7. The computerized-method of claim 1, wherein the pursuit type is selected from at least one of: (i) motivating; (ii) challenging: (iii) engaging; and (iv) rewarding.

8. The computerized-method of claim 1, wherein the difficulty-level is selected from at least one of: (i) easy; (ii) moderate; (iii) hard.

9. The computerized-method of claim 5, wherein when the user does not enter the pursuit type and the difficulty level, the pursuit-type and the difficulty-level are predicted by the recommendation engine and presented to the user via a User Interface (UI) of the cloud-based gamification application.

10. The computerized-method of claim 1, wherein the recommendation engine operates a first machine learning model to predict the pursuit-type and a second machine learning model to predict the difficulty-level.

11. The computerized-method of claim 9, wherein after the pursuit-type and the difficulty-level are presented to the user, the user is enabled to: (i) select via the UI of the cloud-based gamification application a pursuit-template from a list of pursuit-templates; or (ii) realign the pursuit-data, wherein the list of pursuit-templates is retrieved based on the pursuit-type and the difficulty-level and wherein each pursuit-template of the list of pursuit-templates is presented with a related score.

12. The computerized-method of claim 4, wherein the scheduled job is implemented by an Amazon Lambda job.

13. The computerized-method of claim 1, wherein the first cloud-object-storage and the second cloud-object-storage are implemented by an Amazon S3 bucket.

14. The computerized-method of claim 3, wherein each participant of a completed pursuit provides a feedback, and wherein the participants-feedback includes at least one of: (i) feedback as to difficulty-level; and (ii) feedback as to pursuit-type.

15. The computerized-method of claim 1, wherein the recommendation engine exposes an Application Programming Interface (API) to retrieve the one or more pursuit-templates, and wherein the API is selected from: (i) Representational State Transfer (REST) API; or (ii) Simple Object Access Protocol (SOAP) API.

16. The computerized-method of claim 9, wherein the recommendation engine presents the predicted difficulty-level and the pursuit-type by exposing an Application Programming Interface (API) to return difficulty-level and the pursuit-type.

17. The computerized-method of claim 1, wherein the machine-learning models and their accuracy score are dumped as pickle files in the first cloud-object-storage and wherein the pickle files are deployed by using a web application framework or a cloud machine-learning platform.

18. The computerized-method of claim 16, wherein the web application framework is Flask and the cloud machine-learning platform is Amazon Web Service (AWS) SageMaker.

19. The computerized-method of claim 1, wherein the data store of pursuit-data associated with the pursuit microservice is implemented by an Amazon Relational Database Service (RDS).

20. The computerized-method of claim 1, wherein the duration to complete the pursuit is a range of duration to complete the pursuit and the expected percentage increase in the performance of the KPI is a range of expected increase in the performance of the KPI.

21. The computerized-method of claim 5, wherein the entity is an agent or a team of agents, and wherein the user is a manager or a supervisor.
